(19) United States
(12) Patent Application Publication
(10) Pub. No.: US 2026/0228805 A1
(43) Pub. Date: Aug. 6, 2026

(54) Graphical User Interface for Facilitating Transactions Onboard an Aircraft

(71) Applicant: ViaSat, Inc., Carlsbad, CA (US)

(72) Inventor: Ultan O'Brien, Carrickmines (IE)

(21) Appl. No.: 19/148,677

(22) PCT Filed: Jan. 17, 2023
(86) PCT No.: PCT/US2023/010927

§ 371 Date: Jul. 16, 2025

(51) Int. Cl. G06Q 30/0601

(52) U.S. Cl. CPC G06Q 30/0641

(57) ABSTRACT

A technology is described for facilitating destination specific transactions onboard an aircraft using a graphical user interface of an electronic device. In one example of the technology, a destination of a current flight can be determined from flight context information obtained from an aircraft data bus. The destination can be used to identify video content related to the destination, and the video content can be provided for display in a graphical user interface of an inflight entertainment system, wherein the video content can be displayed with an embedded purchase element that provides details for an offer available at the destination. A passenger can select the embedded purchase element displayed in the graphical user interface to initiate an onboard transaction to purchase the product or service associated with the offer available at the destination.

### BACKGROUND

An inflight entertainment (IFE) system and related information systems may provide entertainment, moving map information, flight information, or other information to aircraft passengers during a flight. IFE systems can include centralized display monitors, seat back display monitors and/or connections for personal electronic devices via a wireless network, which may enable aircraft passengers to consume media content comprising, for example, one or more of audio content, video content, moving map information, electronic games, shopping information, advertisements, location information, flight information, travel information, etc. The media content can include music, news, comedy, etc. The video content can include television programs, movies, live television programs (e.g., live news programs, live sporting events), cable programs, etc.

In one example, IFE systems can provide in-flight network connectivity to personal electronic devices, such as mobile phones, laptops, or tablet computers. For instance, IFE systems may allow passengers to consume audio content, video content, games, maps, etc. using the personal electronic devices. The personal electronic devices can receive the audio content, video content, games, maps, shopping information, etc. from a server onboard the aircraft via a wireless access point (e.g., a WI-FI access point) in the aircraft.

Further, IFE systems may provide in-cabin internet service, allowing aircraft passengers to perform activities, such as internet browsing, media viewing, shopping, texting, messaging, emailing, etc. using their personal electronic devices. Inflight internet service can be provided through a satellite network in communication with communications hardware on the aircraft that enables aircraft passengers to connect to the internet from personal electronic devices via the wireless access point.

### SUMMARY

A system for facilitating destination specific transactions onboard an aircraft using a graphical user interface of an electronic device is provided and can include at least one processor and a memory device including instructions that, when executed by the at least one processor, cause the system to perform defined operations. One operation may determine a destination of a flight from flight context information obtained from an aircraft data bus, and the flight context information may be obtained from an aircraft information system located on the aircraft. Another operation may identify video content that is related to the destination of the flight. The video content for display in the graphical user interface may be provided with an embedded purchase element to display details for an offer available at the destination and to initiate an onboard transaction to purchase the offer available at the destination, wherein the embedded purchase element is displayed during at least a portion of playback of the video content in the graphical user interface. A passenger-activation of the embedded purchase element in the video content displayed in the graphical user interface may also be received to initiate the onboard transaction to accept the offer available at the destination in response to receiving the passenger-activation of the embedded purchase element in the video content displayed in the graphical user interface.

A method for transactions onboard an aircraft using a graphical user interface is provided. The method can include determining a destination of a flight from flight context information obtained from an aircraft data bus, wherein the flight context information is from an aircraft information system located on the aircraft The method can further include identifying video content that is related to the destination of the flight and providing the video content for display in the graphical user interface with an embedded purchase element to display details for an offer available at the destination and to initiate an onboard transaction to purchase the offer available at the destination. The embedded purchase element can be displayed during at least a portion of playback of the video content in the graphical user interface The method can further include receiving a passenger-activation of the embedded purchase element in the video content displayed in the graphical user interface and initiating the onboard transaction to accept the offer available at the destination in response to receiving the passenger-activation of the embedded purchase element in the video content displayed in the graphical user interface.

A non-transitory machine-readable storage medium, including instructions embodied thereon, can when executed by at least one processor, perform defined operations. One operation can determine a destination of a flight from flight context information obtained from an aircraft data bus, wherein the flight context information is from an aircraft information system located on the aircraft. Another operation can identify video content that is related to the destination of the flight and provide the video content for display in the graphical user interface with an embedded purchase element to display details for an offer available at the destination and to initiate an onboard transaction to purchase the offer available at the destination. The embedded purchase element can be displayed during at least a portion of playback of the video content in the graphical user interface. Another operation can receive a passenger-activation of the embedded purchase element in the video content displayed in the graphical user interface and initiate the onboard transaction to accept the offer available at the destination in response to receiving the passenger-activation of the embedded purchase element in the video content displayed in the graphical user interface.

### BRIEF DESCRIPTION OF THE DRAWINGS

FIG. 1 is a block diagram that illustrates an example system for facilitating destination-specific transactions onboard an aircraft using a graphical user interface of an inflight entertainment (IFE) system.

FIG. 2 is a block diagram illustrating another example system to provide a personalized destination-specific offer to a passenger on an aircraft via an embedded purchase element displayed with a video.

FIG. 3 is a block diagram that illustrates an example system for providing an IFE system to client devices on an aircraft.

FIGS. 4A-G are diagrams illustrating example graphical user interfaces of an IFE system that enable a passenger to access IFE features and sub-interfaces and allow the passenger to view destination-specific media or videos and embedded purchase elements.

FIG. 5 is a flow diagram that illustrates an example method for facilitating destination specific transactions onboard an aircraft using a graphical user interface displayed by an electronic device.

FIG. 6 is a satellite communication system according to an example of the present technology.

FIG. 7 is a block diagram that provides an example illustration of a computing device that may be employed in the present technology.

### DETAILED DESCRIPTION

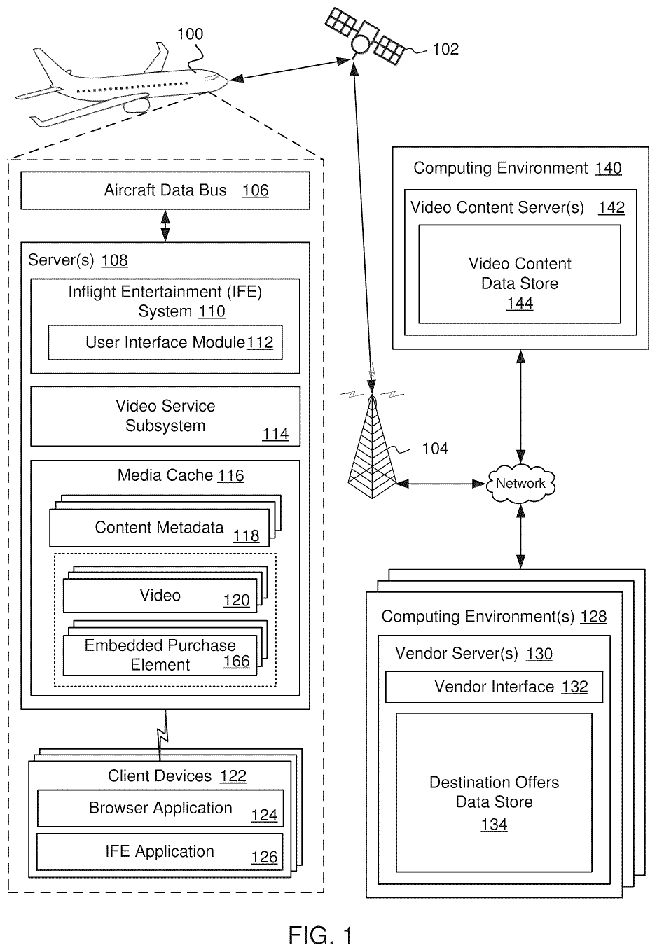

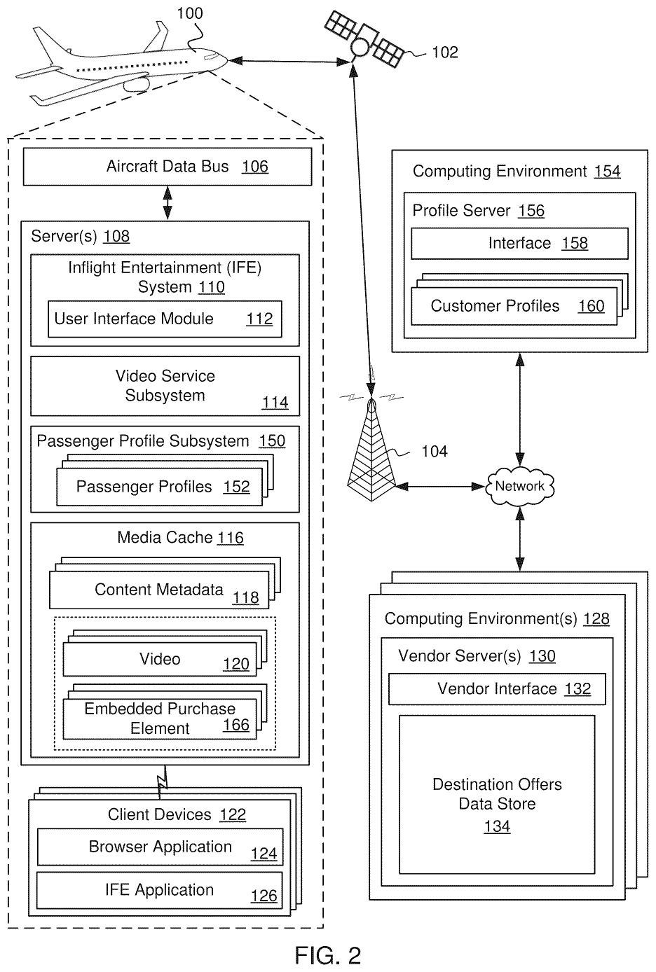

FIG. 1 illustrates one example of a system configured to facilitate destination-specific transactions onboard an aircraft 100 using a graphical user interface of an inflight entertainment (IFE) system 110. An aircraft 100 may be one of multiple aircrafts which are included in a fleet of aircrafts. One or more servers 108 onboard an aircraft 100 may host the IFE system 110, which can be configured to provide passengers access to various media content displayed on or accessed via client devices 122 or other media display devices (such as centralized display monitors, seat back display monitors, and so forth). The term “passenger” is used herein to refer to a passenger on an aircraft 100 who is also a customer who views media or video content displayed in the graphical user interface of the IFE system 110 and purchases products and services offered via an embedded purchase element (e.g., button, link, QR code, etc.) shown in the media content during a flight. As used herein, the term “flight” can refer to a route of an aircraft 100, which may include one or more layover destinations, or a flight may refer to a route of a passenger, who may board one or more aircraft 100 in order to reach the passenger's final destination.

Passengers of the aircraft 100 can access the IFE system 110 using client devices 122 that include passenger computing devices (e.g., smartphones, tablet computers, laptop computers, etc.) and/or aircraft computing devices (e.g., seatback computing devices). The IFE system 110 may include a graphical user interface to allow the passengers to access the IFE system 110. Illustratively, the graphical user interface can be provided (e.g., transmitted to a client device 122) by the user interface module 112 to enable the passengers on the aircraft 100 to view movies and television programs, listen to audio, play electronic games, view status maps, and the like. In particular, the IFE system 110 may enable a passenger to view videos 120 (and other types of media) related to a destination of a flight and allow the passenger to purchase a product or service via an embedded purchase element shown in the video 120. The embedded purchase element 166 can display details or connect to details for an offer to purchase a product or service that may be available at a destination of the flight, and the passenger can interact with the embedded purchase element (e.g., select a button or scan an optical code) to initiate a transaction to purchase the product or service.

Videos 120 made available to passengers through the IFE system 110 during a flight can include featured destination videos, branded product videos, educational videos, tutorial videos, and the like. While the examples and discussion herein are described in the context of and with reference to the videos 120, it will be appreciated that the videos 120 may be replaced or otherwise correspond to other media, including other visual media (such as static images, sequences of images, multimedia, etc.) and so forth. The videos 120 may be associated with a destination of a flight (e.g., a geographic location and/or an attraction), and the videos 120 can be displayed in the graphical user interface of the IFE system 110 with an embedded purchase element that enables a passenger to purchase a product and/or service associated with the destination of the flight. A destination video, branded product video, educational video, tutorial video, and the like can feature a product or service associated with a destination of a flight, and an embedded purchase element displayed with the video during playback can present an offer to purchase the product or service associated with the destination or other attribute of the flight.

As an illustration, a featured destination video can showcase or feature a destination (e.g., Paris, France) of a flight. The video can include the embedded purchase element that is displayed during or after playback of the video and invites a passenger viewing the video to purchase a product and/or service related to the destination (e.g., a guided tour of the destination from a tour operator, etc.). As another illustration, a tutorial video (e.g., a beauty tutorial) can provide instructions for using a product (e.g., facial makeup) that has an association with the destination (e.g., home to a company headquarters), and a purchase element embedded in the tutorial video can display a call-to-action to invite the viewing passenger to purchase the product (e.g., facial makeup). Although the present disclosure generally describes an embedded purchase element 166 as being embedded in the video 120, it is to be understood that the technology described herein includes embedding purchase elements 166 in other types of media content, such as articles, guides, web pages, images, social media posts, maps, and the like.

In some embodiments, a video content creator can provide both a video 120 and an embedded purchase element 166 to be presented to a passenger or user on an aircraft 100 via the IFE system 110. When the video content created provides both the video 120 and the embedded purchase element 166, the embedded purchase element 166 can be linked to an offer to purchase a product or service that has an association (e.g., geographical, economical, seasonal, cultural, political, etc.) with the content of the video 120. As an illustration, the video content creator can create an embedded purchase element that references an offer to book a wine tasting tour at a winery in Napa Valley and embed the embedded purchase element within a video featuring wineries in Napa Valley in California. The embedded purchase element can contain an offer identifier that references the wine tasting tour that can be used by a vendor server 130 to identify the offer in a destination offers data store 134, as described in more detail herein. This video and embedded purchase element can be provided, for example, to a passenger traveling to northern California.

An embedded purchase element 166 can be shown in or integrated with a video 120 so as to not substantially interfere with the content of the video 120. For example, an embedded purchase element 166 can be sized and placed in a location of a video 120 visible to a passenger (e.g., top, bottom, or side location), but which does not block a substantial amount of content being presented in the video 120 (e.g., less than a quarter, eighth, tenth, etc., of a content display area). Also, an embedded purchase element 166 can be displayed to or be accessible by the user for an entire duration of a video 120 (i.e., from start to finish), or during just a portion of a video 120 (e.g., during a defined segment or for a defined amount of time). In the case that an embedded purchase element 166 is shown or accessible during a portion of a video 120, the content shown or accessible during that portion of the video 120 may correspond to a product or service being offered with the embedded purchase element 166. As a specific example, a portion of a video 120 may feature, or incidentally show, a brand of jewelry that is associated with a destination (e.g., a local showroom), and an embedded purchase element 166 shown in the video 120 during that portion may display an offer for the brand of jewelry.

An embedded purchase element 166 included in a video 120 can be or comprise an interactive element, such as a call-to-action button, a text button, a drop-down button, a hyperlink, a banner ad, a machine-readable code (e.g., QR code), or another type of user interface element that can be embedded into a video 120. In some embodiments, the interactive element may comprise an entirety of the embedded purchase element 166, an entirety of the video 120, a portion of the embedded purchase element (such as an indicated button or component thereof), a portion of the video 120 (such as a displayed image, etc.), and so forth. For example, in a video 120 that features a brand of jewelry associated with a destination, an embedded purchase element 166 may comprise an indicated interactive element (such as a text button) that a passenger or user can select or activate in order to indicate an action with respect to an offer for the brand of jewelry. Alternatively, the indicated interactive element may correspond to the displayed brand of jewelry (for example, a displayed piece of jewelry or a name or logo for the brand of jewelry) or the video 120 itself. Thus, the passenger or user can select any one of the text button, the displayed piece of jewelry, the displayed name or logo for the brand of jewelry, or the video 120 to indicate the action with respect to the offer. The indicated action may correspond to the passenger or user requesting additional information about the offer, accepting the offer, rejecting the offer, and so forth.

In some embodiments, the embedded purchase element 166 can display or show details for an offer available at a destination of a flight. For example, the details shown in the embedded purchase element 166 can identify a product or service being offered (e.g., a city tour, a hotel room, attraction tickets, a product name, etc.), and identify particulars of the offer (e.g., pricing information, date or timing information, restrictions, product information, etc.), present a call-to-action to accept the offer (e.g., “buy”, “reserve”, “claim”, etc.), as well as other details. Further, the embedded purchase element 166 can be configured to initiate an onboard transaction, for example, when a passenger or user accepts the offer described in the embedded purchase element 166 based on the passenger's or user's interaction with the corresponding interactive element. As one example, a passenger can select the embedded purchase element 166 displayed with the video 120, and a function may execute that initiates a transaction by sending a request (e.g., a vendor application programming interface (API) request) to a vendor server 130 requesting that the vendor server 130 execute a transaction for a product or service offered through the embedded purchase element 166. As another example, in the case that an embedded purchase element 166 is a machine-readable code (e.g., QR code), a passenger can scan the embedded purchase element 166 using a client device 122, which causes the client device 122 to initiate a transaction by connecting to the vendor server 130 and requesting that the vendor server 130 execute the transaction for a product or service offered via the embedded purchase element 166. In response to receiving a request to execute a transaction, the vendor server 130 may perform various steps associated with purchasing a product or service, and the vendor server 130 may send order fulfilment information (e.g., purchase confirmation, receipt, digital ticket, pickup instructions, delivery information, itinerary, etc.) to a client device 122 or to an account (e.g., an e-mail address, a user account, etc.) associated with the passenger.

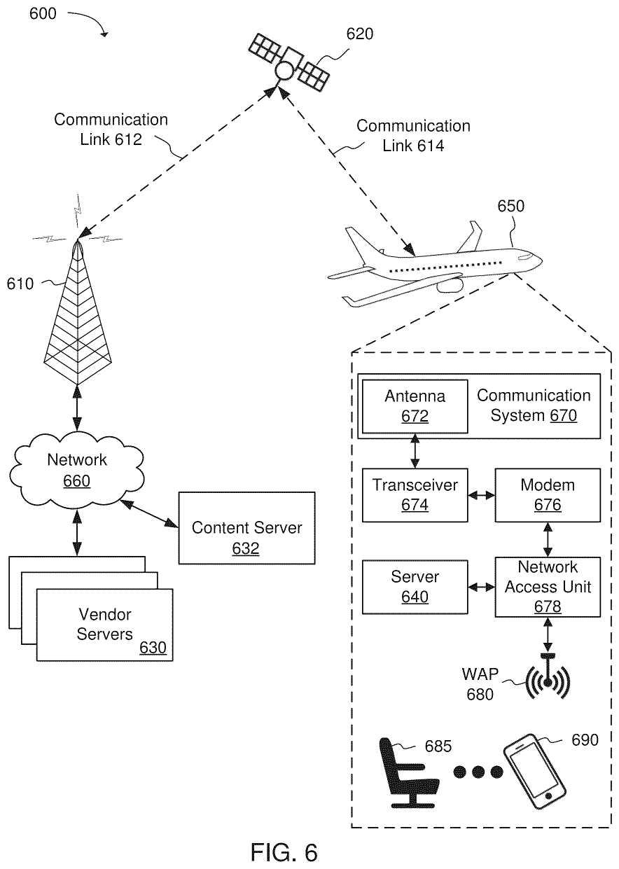

The server(s) 108 onboard the aircraft 100 can host various systems and subsystems used to implement the present technology. For example, the server(s) 108 can host the IFE system 110, a video service subsystem 114, and other subsystems. The server(s) 108 may be in network connection with a plurality of client devices 122 to allow passengers to interact with the IFE system 110. The client device 122 can be a personal electronic device, such as a mobile phone or a tablet computer, and a connection between the client device 122 and the server 108 may be a wireless connection established via a wireless access point (as shown in FIG. 6). In another example, the client device 122 may be a seatback system installed on a passenger seat of the aircraft 100, and a connection between the client device 122 and the server 108 may be a wired or wireless connection. In one example, the client device 122 can host an IFE application 126 and/or a browser application 124 that interfaces with a user interface module 112 included in the IFE system 110 to present video content to a passenger.

Video content presented to a passenger using the client device 122 can be selected by the video service subsystem 114. The video service subsystem 114 can obtain flight context information for a current flight, for example, from an aircraft data bus 106 and determine at least one destination from the flight context information. A destination obtained from the flight context information can be an aircraft destination (e.g., a destination city, airport, arrival terminal, arrival gate, etc.), which can include multiple destinations (e.g., one or more layover destinations and an aircraft final destination). In another example described later in association with FIG. 2, the destination can be one or more passenger destinations (e.g., one or more layover destinations and a final destination of a passenger, which may be different from an aircraft destination). The aircraft data bus 106 may receive aircraft flight context information from a plurality of aircraft information systems, including navigation, weather systems, communications, aircraft networks, and other avionics, located on the aircraft 100. The flight context information available from the aircraft data bus 106 may be information that is specific to the aircraft 100 for a specific time period. As an example, the flight context information may include: an aircraft origin, an aircraft destination, an estimated arrival time, an arrival gate, a current latitude and longitude of the aircraft, a current aircraft speed, a current aircraft altitude, a passenger service status (e.g., meal service, drink service, etc.), an origin weather report, as well as other information available from the aircraft information systems. The aircraft information systems located on the aircraft 100 may communicate the aircraft flight information to each other using the aircraft data bus 106. The video service subsystem 114 can obtain flight context information from the aircraft data bus 106 at any time (i.e., prior to and/or during a flight).

After determining one or more destinations of an aircraft 100, the video service subsystem 114 can use an aircraft destination (e.g., a destination city, airport, arrival terminal, arrival gate, etc.) to identify video content related to the aircraft destination and an embedded purchase element 166 to display with the video content in the graphical user interface of the IFE system 110. A media cache 116 located onboard the aircraft 100 can be used to temporarily store videos 120 and content metadata 118 for a segment of the aircraft's route (e.g., “flight leg”) or for an entire duration of the aircraft's route from a starting location to a final aircraft destination. Videos 120 and content metadata 118 temporarily stored in the media cache 116 can be obtained from a video content server 142 that manages a video content data store 144.

In one example, the media cache 116 located onboard the aircraft 100 can include videos 120 with embedded purchase elements 166. More specifically, a video file stored in the media cache 116 can contain both video data and an embedded purchase element that is displayed during playback of the video. The media cache 116 can also contain content metadata 118 that describes an association between a video 120 and an aircraft destination. For example, content metadata 118 for a video 120 may describe the video content as featuring a place, landmark, activity, product, or other aspect that may be related in some way to an aircraft destination. In some examples, the content metadata 118 may describe a vendor, a product, a service, search keywords, or other content related to the electronic offering item. The content metadata 118 may also include information that links the video 120 and/or the embedded purchase element 166 with destination information of the aircraft 100, such as an address, zip code, area code, landmark, and other types of location identifying information. The video service subsystem 114 can query the content metadata 118 to identify one or more videos 120 that are related in some way to a destination of the aircraft 100 (e.g., a layover destination or a final destination of the aircraft 100) and make the videos 120 available for playback in the graphical user interface of the IFE system 110.

In another example, the media cache may store videos 120 and embedded purchase elements 166 as separate files to allow the video service subsystem 114 to select an embedded purchase element 166 to include with a video 120. For example, the video service subsystem 114 can identify a video 120 that is associated with a destination of the aircraft 100 and identify an offer featured in an embedded purchase element 166 to include with the video 120. As an illustration, the video service subsystem 114 can query content metadata 118 for videos 120 to identify a video 120 that is related to an aircraft destination, and query content metadata 118 for embedded purchase elements 166 to identify an embedded purchase element 166 associated with an offer that is also related to the aircraft destination and/or the video 120. The metadata 118 can be stored in various locations. In some embodiments, the metadata 118 can be stored in tables and fields within the media cache 116. In some embodiments, the metadata 118 can be located in a document or database specifically designed to store such data, called a data dictionary or metadata repository. The metadata may be created by a video producer, marketing executive or other content producer or manager. During playback of the video 120 in the graphical user interface of the IFE system 110, the video service subsystem 114 can cause the identified embedded purchase element 166 to be displayed with the video 120 (e.g., by overlaying the embedded purchase element 166 on the video 120).

The video service subsystem 114 can send a list of destination-specific videos for display in the graphical user interface of the IFE system 110, which are available for viewing on the aircraft 100 and contain video content related to a destination of the aircraft. A passenger can access the list of destination-specific videos using a client device 122 and the graphical user interface (e.g., IFE application 126) of the IFE system 110. The passenger can select a video 120 from a list, and during playback of the video 120, an embedded purchase element 166 displayed with the video content can show details for an offer available at the aircraft destination. Also, in some embodiments, the video service subsystem 114 can playback a destination-specific video in the graphical user interface of the IFE system 110 as an advertisement or during an advertisement of an offer, and during playback of the video 120, an embedded purchase element 166 associated with the offer can be displayed with the video content.

In one example configuration, when determining which videos 120 to include in a listing of destination-specific videos, the video service subsystem 114 can evaluate flight context information to determine a current status of a flight (e.g., parked at gate, takeoff, in-flight, distance to destination, meal service, landing approach, etc.) and select videos 120 to include in the listing of destination-specific videos based in part on the current status of the flight. For example, the video service subsystem 114 may monitor aircraft flight information obtained from the aircraft data bus 106 for events that may correspond to an opportunity to promote an offer via an embedded purchase element 166 in a video 120 made available through the IFE system 110. For instance, the video service subsystem 114 may monitor an aircraft latitude and longitude, an aircraft altitude, a seatbelt warning status, an announcement related to turbulence, safety, food service, weather, an estimated arrival time, an arrival gate, etc. The video service subsystem 114 may then review content metadata 118 for videos 120 and embedded purchase elements 166 to identify one or more videos 120 and embedded purchase elements 166 that are associated with the monitored aircraft flight information, where each of videos 120 and the embedded purchase elements 166 include metadata associated with different possible monitored aircraft flight information. The associated videos 120 and/or embedded purchase elements 166 may be presented by the video service subsystem 114 to a passenger.

As an example, shortly after takeoff, the video service subsystem 114 may select a video 120 to make available through the IFE system 110 that features the “best hotels” in Cancun, Mexico and includes an embedded purchase element 166 linked to an offer for one of the hotels featured in the video, thereby allowing a passenger who views the video 120 to interact with the embedded purchase element 166 and book a room at the hotel prior to arriving in Cancun. As another example, in response to detecting that a meal service is starting on an aircraft 100, the video service subsystem 114 may select a video 120 to make available through the IFE system 110 that features a destination duty-free shop and includes an embedded purchase element 166 linked to an offer for wine and spirits from the duty-free shop at the aircraft destination, which may be of more interest to passengers around a time that snacks or meals are being distributed to passengers on the aircraft 100. As yet another example, the current status of a flight may indicate a change in destination due to weather or some other event, and the video service subsystem 114 can obtain an updated set of videos 120 (e.g., from the video content servers 142) using the new destination and make the videos 120 available to passengers through the IFE system 110. For example, an unexpected layover due to the change in destination may prompt the video subsystem to provide videos and offers for reserving one or more of hotels, meals, transportation, etc., at the layover destination.

While viewing a video 120 through the IFE system 110, a passenger, via a client device 122, can purchase a product and/or service offered through an embedded purchase element 166. For example, the passenger can initiate a purchase transaction for a product and/or service by interacting with the embedded purchase element 166, such as selecting an interactive element (e.g., a button) shown in the embedded purchase element 166 which, when selected, causes the video service subsystem 114 to initiate the purchase transaction, as explained below.

The video service subsystem 114 can receive a passenger-activation or passenger-selection of an embedded purchase element 166 displayed with video content in the graphical user interface. In response to the passenger-activation of the embedded purchase element 166, the video service subsystem 114 may initiate a purchase transaction by sending a message to a vendor server 130 requesting that the vendor server 130 process a purchase transaction for a product or service offered via the embedded purchase element 166. The message can contain a reference (e.g., offer identifier) to the offer made available to a passenger through the embedded purchase element 166. The video service subsystem 114 can send the message to a vendor server 130, via a vendor interface 132, which manages transactions for products and/or services available at various destination locations. The vendor interface 132 can be an API, and the video service subsystem 114 can send an API request from the server 108 located on the aircraft 100 to the vendor server 130 over either a satellite network 102/104 when the aircraft 100 is inflight, or a terrestrial wireless network (not shown) when the aircraft 100 is on the ground. The vendor server(s) 130 may be located off the aircraft 100 in separate computing environments 128 (e.g., a private cloud environment, a data center, centralized hardware servers, a data warehouse, etc.). In one example, each vendor server 130 may be associated with an individual vendor (e.g., tour guide operator, hotel operator, rental car operator, ride sharing operator, duty-free shop, fashion store, bookstore, etc.). In another example, a vendor server 130 may aggregate products and services offers for a plurality of vendors.

The vendor servers 130 may manage product and/or service offers stored in a destination offers data store 134 on behalf of a vendor. A vendor may be a business, organization, non-profit entity, government agency (e.g., tickets to government attractions or national parks), individual, or other third-party that offers their destination-specific products and/or services through embedded purchase elements 166 shown with videos 120 provided to passengers on an aircraft 100. An embedded purchase element 166 can reference a specific offer contained in the destination offers data store 134. When a passenger interacts with an embedded purchase element 166, a reference (e.g., offer identifier) to an offer for a product or service offered via the embedded purchase element 166 can be sent to the vendor server 130 to allow the vendor server 130 to identify a destination offer in the data store 134.

Destination offers managed by a vendor server 130 can include details for a vendor's products and/or services, including the vendor's contact information (e.g., address, website address, email address, phone number, etc.), product and/or service information (e.g., description, photos, price, availability, itinerary, etc.), and other information associated with the offer.

The vendor interface 132 for the vendor server(s) 130 can receive a request from the video service subsystem 114 to process a purchase transaction. In response, the vendor server 130 can identify an offer in the destination offers data store 134 that is associated with an offer identifier included in the request and process the transaction for a product and/or service associated with the offer. For example, the vendor interface 132 can interact with the video service subsystem 114 to obtain passenger information and payment information needed to process the transaction and provide order fulfilment information to the passenger. As a non-limiting example, in response to receiving a purchase transaction request for a guided tour of Dublin, Ireland, the vendor interface 132 may process the transaction by: i) querying the destination offer data store 134 to verify that the requested tour is available, ii) obtaining passenger information and payment from the passenger, and then iii) providing a receipt, itinerary, meetup instructions, etc., to the passenger. In response to receiving order fulfillment information from the vendor interface 132, the video service subsystem 114 can display the order fulfilment information in the graphical user interface of the IFE system 110. Also, in one example, the vendor interface 132 can electronically send a passenger order fulfillment information via email, SMS message, or other method.

In order to ensure that videos 120 relevant to an aircraft destination are available to passengers on an aircraft 100, videos 120 and associated content metadata 118 stored in the media cache 116 can be updated periodically to include videos 120 associated with one or more destinations included in a planned route of an aircraft 100. In one example, the video service subsystem 114 can update the videos 120 and content metadata 118 stored on the media cache 116. The video service subsystem 114 can obtain videos 120 and content metadata 118 from a video content server 142 located in a remote computing environment 140. Further, the video service subsystem 114 can update the videos 120 and content metadata 118 stored in the media cache 116 located on the aircraft 100 with the videos 120 and content metadata 118 received from the video content server 142. For example, the video service subsystem 114 can send aircraft destination information to the video content server 142, and the video content server 142 can query a video content data store 144 located in the remote computing environment 140 for videos that are related to the aircraft destination. In one example, the video service subsystem 114 can obtain videos 120 and content metadata 118 for a plurality of destinations (e.g., both aircraft and passenger destinations) from the video content server 142 and store the videos 120 and content metadata 118 in the media cache 116.

The video service subsystem 114 can request videos 120 and content metadata 118 from video content servers 142 at any time, including prior to takeoff, during a flight, and after landing, regardless of whether or not passengers may be using the IFE system 110. In one example, the media cache 116 can be updated when the aircraft 100 is on the ground (e.g., at an airport terminal) to allow use of a terrestrial network to connect to the video content servers 142 due to increased costs associated with receiving data when the aircraft 100 is inflight. In another example, the media cache 116 can be updated when the aircraft 100 is in the air using a satellite network 102/104 to connect to the video content servers 142 in order to provide passengers with the most up-to-date offers available from associated vendors. In one aspect, the video service subsystem 114 may obtain a video 120 and embedded purchase element 166 from a video content server 142 when the aircraft 100 is within a certain distance (e.g., 100 miles) of a destination to ensure availability of a product and/or service when a passenger arrives at the destination. The video service subsystem 114 can obtain, from the video content servers 142, videos 120 associated with destinations included in a planned route of an aircraft 100 and store the videos 120 in the media cache 116. In one example, the video service subsystem 114 may store a library of videos onboard the aircraft 100 which are associated with a plurality of destinations that may be outside of the planned route of the aircraft 100 (but are within a defined region) to ensure that a video 120 associated with a destination is available in the event that a current destination of the aircraft 100 is changed for some reason (e.g., due to weather, mechanical problem, or other reasons).

As shown, the IFE system 110 can include a user interface module 112, which can comprise a graphical user interface of a web application or client server application that can be sent to the client devices 122. The user interface module 112 can provide interface controls for accessing and navigating a home screen, media content, shopping information, aircraft information, and the like. In particular, the user interface module 112 for the IFE system 110 provides access to the videos 120 described earlier. For example, the graphical user interface provided by the user interface module 112 can include a button, a menu item, a radio button, a drop down lists, checkboxes, or other interface controls that instructs the video service subsystem 114 to obtain a listing of videos 120 related to an aircraft destination and display video content of a video 120 selected for playback in the graphical user interface of the IFE system 110.

FIG. 2 illustrates an example of a system that utilizes a passenger profile subsystem 150 to provide a personalized or targeted destination-specific offer to a passenger on an aircraft 100 via an embedded purchase element displayed with a video 120. In this example, the server 108 located onboard the aircraft 100 may host a passenger profile subsystem 150 configured to obtain passenger information for one or more passengers on the aircraft 100. Passenger information for a passenger may be used to identify destination-specific videos 120 (or embedded purchase elements 166) that may be of interest to the passenger. The passenger information can include demographic information, itinerary information that describes travel of the passenger, frequent flyer information, rewards points, customer rewards statuses, and/or interest information for the passenger. The interest information can include one or more behavioral attributes of the passenger, such as a propensity to purchase certain products, interests related to searches, previously consumed media content by the passenger, previous purchases, etc.

In one example, the passenger profile subsystem 150 may create a passenger profile 152 for a passenger on the aircraft 100 based on input (e.g., user profile information) received from a client device 122 associated with the passenger. For example, the passenger profile subsystem 150 may receive demographic information, itinerary information, and/or interest information from the client device 122 and use this information to create the passenger profile 152. In one example, a passenger may provide passenger information during a flight by inputting the passenger information into the user interface module 112 of the IFE system 110. For example, a graphical user interface can prompt a passenger to provide passenger information using a series of questions, checkboxes, forms, etc. The passenger profile subsystem 150 may receive passenger information input by a passenger and create a locally stored passenger profile 152 for the passenger.

Additionally, or alternatively, the passenger profile subsystem 150 may obtain a customer profile 160 associated with a passenger from an off-board profile server 156. In some embodiments, the off-board profile server 156 is associated with an aircraft operator. The profile server 156 may be located in a computing environment 154 (e.g., a private cloud environment, a data center, centralized hardware servers, a data warehouse, etc.). The profile server 156 may manage customer profiles 160 for passengers. The customer profiles 160 may include, for example, demographic information, itinerary information, customer interest information, etc. In one example, customer interest information included in a customer profile 160 can include one or more preferences, such as certain products that are of interest to the passenger (e.g., electronic devices, fashion, sports cars, etc.), and activities that are of interest to the passenger (e.g., hiking, skiing, hunting, yoga, etc.) that may be used to identify related products (e.g., athletic wear and sporting equipment). In other words, the customer interest information may describe behavioral attributes of the passenger (e.g., a propensity to consume certain types of services, content or perform certain types of activities).

The profile server 156 may make the customer profiles 160 available to the passenger profile subsystem 150. For example, the profile server 156 may include an interface control 158, such as an API, and the passenger profile subsystem 150 may send a request to the API that includes identifying information for a passenger (e.g., customer number, frequent flyer number, etc.). In response to receiving the request, the profile server 156 may identify a customer profile 160 associated with the identifying information, and the API may send the customer profile 160 to the server 108 located onboard the aircraft 100 to allow the passenger profile subsystem 150 to create a locally stored passenger profile 152 using the information in the customer profile 160.

In addition to demographic information, itinerary information, and/or customer interest information, a customer profile 160 obtained from the profile server 156 can include previous electronic purchases or activities of a passenger while onboard previous flights, such as movies or music consumed by the passenger, advertisements interacted with by the passenger, websites visited by the passenger, services or goods purchased, etc. The information in the customer profile 160 can be used to create a passenger profile 152 for the passenger for use during a current flight. During the current flight, the passenger profile subsystem 150 may update the passenger profile 152 to include electronic activities of the passenger while onboard the aircraft 100. Also, the passenger profile subsystem 150 can send the electronic activities of the passenger while on the current flight to the profile server 156 so that the electronic activities can be included in the passenger's customer profile 160 managed by the profile server 156. Alternatively, or additionally, the profile server 156 may update customer profiles 160 based on passenger profile information created or stored by the passenger profile subsystem 150.

Passenger profiles 152 created by the passenger profile subsystem 150 may be made available to the video service subsystem 114. As indicated above, a passenger profile 152 may include itinerary information specifying a final destination for a passenger. The passenger destination specified in the passenger profile 152 may be different from a destination of an aircraft 100 obtained from the aircraft data bus 106. More specifically, the destination obtained from the aircraft data bus 106 may be a destination of the aircraft 100 and not the final destination of the passenger onboard the aircraft 100. After arriving at the aircraft destination, the passenger may take a connecting flight or other transportation (e.g., train or car) to a final passenger destination. Accordingly, the video service subsystem 114 may obtain a passenger destination from a passenger profile 152, and the video service subsystem 114 may use the passenger destination to identify a video and embedded purchase element 166 associated with the passenger destination and provide the video and embedded purchase element 166 to the passenger via the IFE system 110.

In one example configuration, the video service subsystem 114 may provide destination-specific videos 120 to passengers at particular times or events during a flight. For example, some offers presented via embedded purchase elements may be more relevant to passengers at particular times during a flight. Accordingly, in one example, the video service subsystem 114 may monitor aircraft flight information obtained from the aircraft data bus 106 for events that may correspond to an opportunity to promote an offer to a passenger. In response to detecting an event (e.g., a destination change, an announcement that a meal service is starting, final approach to an airport, etc.), the video service subsystem 114 may obtain a video and embedded product element featuring an offer which may be of interest to passengers on the aircraft 100 during the event. The video service subsystem 114 may then provide the video 120 to the IFE system 110 to allow the passengers to view the video 120.

In one example configuration, passenger interaction with the IFE system 110 can be captured. For example, interaction data associated with passenger activities such as viewing movies and shows, playing video games, browsing the internet, etc. can be generated and the interaction data can be saved to a local passenger profile 152 associated with the passenger. In one example, the interaction data can also be sent to the profile server 156 to update a customer profile 160 with the interaction data. The video service subsystem 114 may monitor passenger interaction with the IFE system 110 and identify a video and embedded purchase element 166 featuring an offer that corresponds to the passenger interaction and is available at an aircraft and/or passenger destination. As an example, the video service subsystem 114 may monitor media (e.g., inflight movie or show) viewed by a passenger and determine whether metadata for the media corresponds to content metadata 118 for a destination-specific offer.

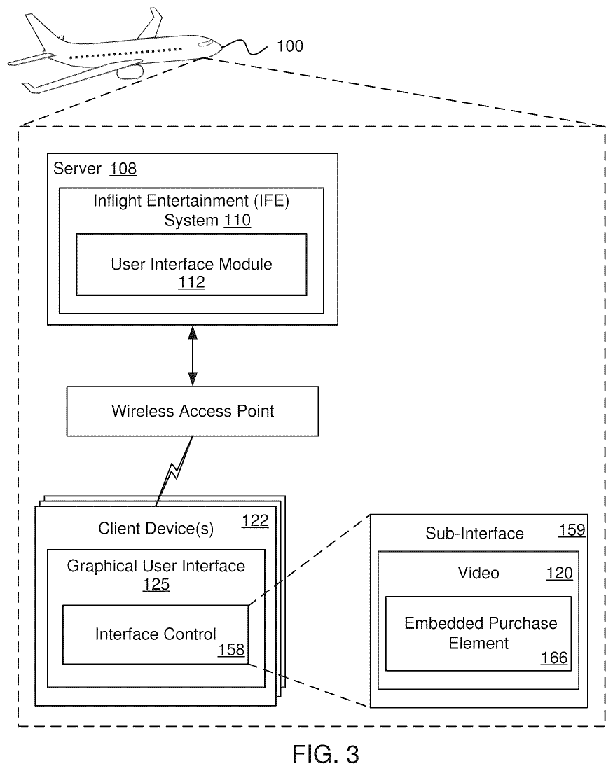

FIG. 3 illustrates an example of a system for providing an IFE system 110 and user interface to client devices 122 on an aircraft 100. As described earlier, the server 108 onboard the aircraft 100 may provide a graphical user interface 125 to client devices 122 via the user interface module 112. The graphical user interface 125 can be provided via a browser application (e.g., a web application) or an IFE application that executes on a client device 122. The graphical user interface 125 may enable a passenger on the aircraft 100 to watch the videos described earlier and interact with an embedded purchase element to purchase a product and/or service available at a destination. The graphical user interface 125 may include an interface control 158 to access categorized listings of destination-specific videos (e.g., tour videos, activity videos, instructional videos, branded product videos, etc.). The interface control 158 may be a graphical user interface (GUI) control, including but not limited to, an electronic link, a tab, a button, menu item, etc., where the interface control 158 may be used to access one or more destination-specific videos and embedded purchase elements. Selection of the interface control 158 may begin playback of a video 120 through a sub-interface 159 of the graphical user interface 125. For example, selecting the interface control 158 of the graphical user interface 125 may cause a video 120 to be opened and displayed through the sub-interface 159. During playback of the video 120, an embedded purchase element 166 may be displayed that enables a passenger to initiate the purchase of a product and/or service described in the embedded purchase element 166, as described earlier.

In one configuration, the server 108 may communicate with a client device(s) 122 via a network. The network may include any useful computing network, including a localized network, a wireless data network, wired network, or any other such network or combination thereof. Components utilized for such a system may depend at least in part upon the type of network and/or environment selected. Generally, a wireless connection between the server 108 and the client device(s) 122 may be established using Transmission Control Protocol/Internet Protocol (TCP/IP), and services in the server 108 may be accessed or exposed using an API protocol, such as an open API protocol, a representational state transfer (REST) API protocol, a simple object access protocol (SOAP), a remote procedure call (RPC) protocol, or the like. A wireless access point (shown as 880 in FIG. 6) that facilitates data traffic between the server 108 and the client device(s) 122 may operate using a WI-FI protocol, a BLUETOOTH protocol, or another appropriate wireless protocol. The various processes and/or other functionality contained within the servers 108/130/142/156 shown in FIGS. 1-3 may be executed on one or more processors that are in communication with one or more memory modules.

The term “data store” may refer to any device or combination of devices capable of storing, accessing, organizing and/or retrieving data, which may include any combination and number of data servers, relational databases, object-oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

FIGS. 1-3 illustrate that certain processing modules or subsystems may be discussed in connection with this technology. In one example configuration, a module or subsystem may be considered a service with one or more processes executing on a server or other computer hardware. For example, modules or subsystems providing services may be hosted in a server located on or off an aircraft or other vehicle. An application programming interface (API) may be provided for each module or subsystem to enable a second module or subsystem to send requests to and receive output from a first module or subsystem. Such APIs may also allow third parties to interface with the module or subsystem and make requests and receive output from the modules or subsystems. While FIGS. 1-3 illustrate examples of systems that may implement the techniques herein, many other similar or different environments are possible. The example environments discussed and illustrated herein are merely representative and are not meant to be limiting. Also, although the examples herein are described in the context of an aircraft, it will be appreciated that the techniques described for providing a video and embedded purchase element to a passenger may be performed in the context of other types of transportation, such as a train, bus, boat, etc.

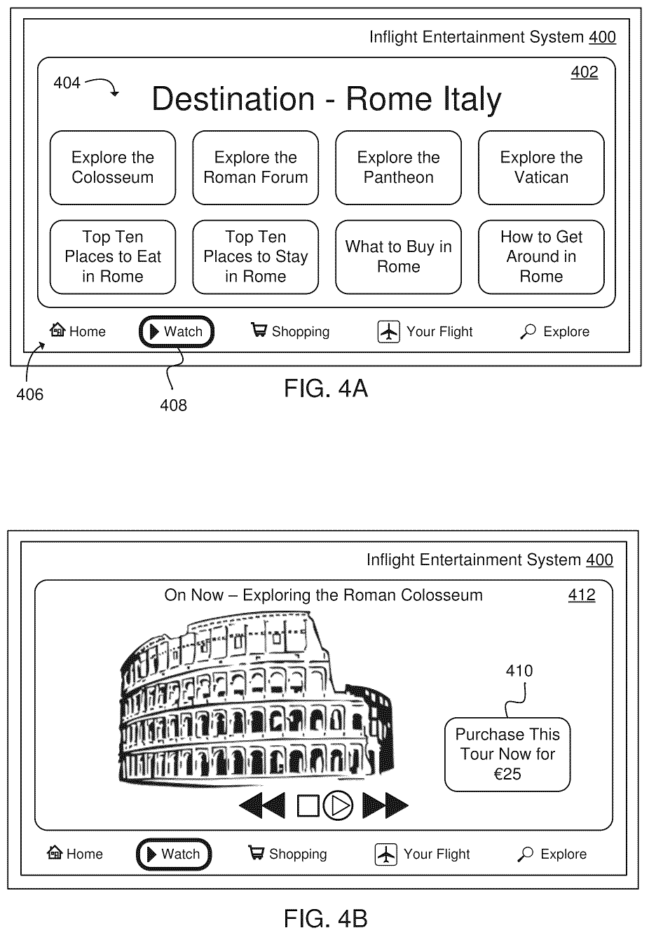

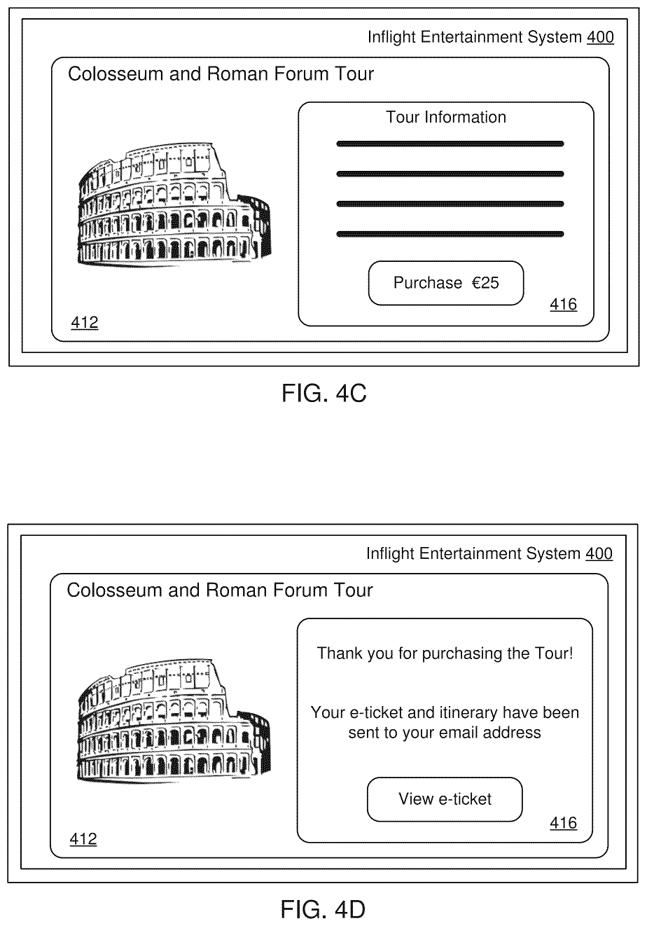

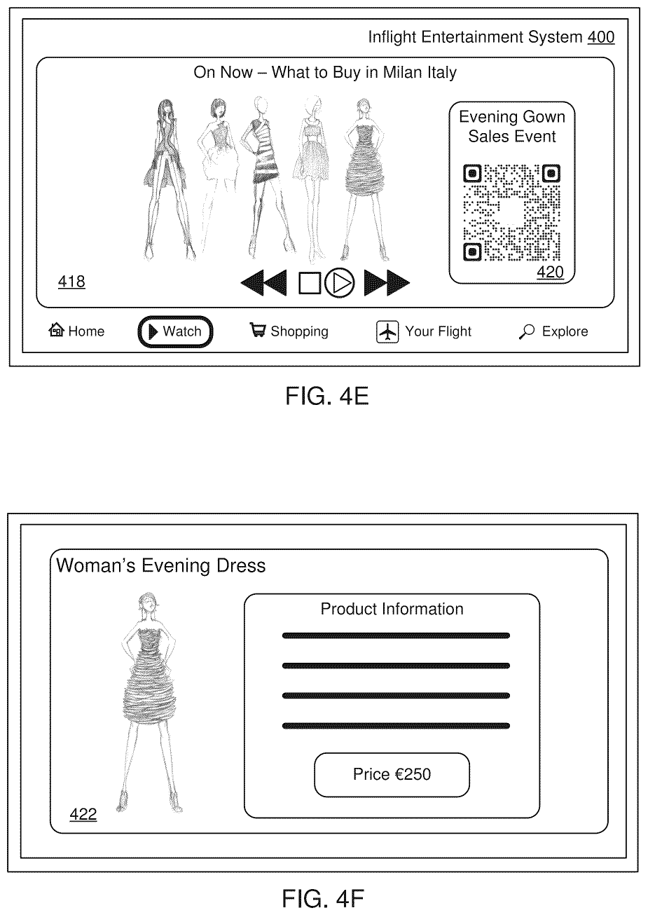

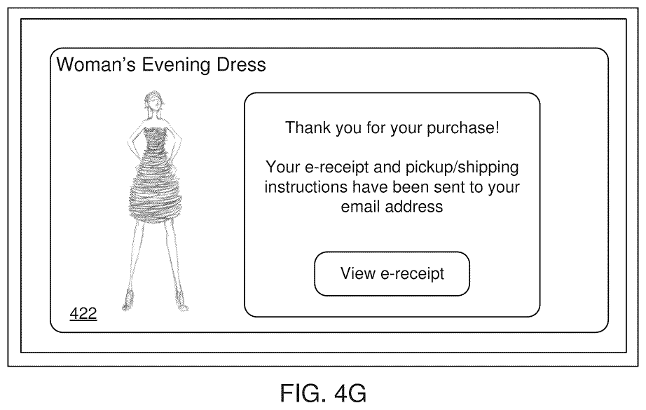

Referring generally to FIGS. 4A-G, an example graphical user interface of an IFE system 400 is illustrated as having an interface that enables a passenger to access IFE features (e.g., media, shopping, flight information, etc.) and a plurality of sub-interfaces that allow the passenger to view destination-specific videos and embedded purchase elements. FIG. 4A illustrates the graphical user interface of the IFE system 400 with controls 406 to access a home screen, inflight media, inflight shopping, flight information, and the like. In particular, the controls 406 can include a “Watch” control 408 that, when selected by a passenger, launches a destination video sub-interface 402 containing a listing of videos 404 associated with a destination (e.g., an aircraft destination or a passenger destination). In one example, the destination video sub-interface 402 can provide a travel destination guide to a passenger. The travel destination guide can include a plurality of video content categories (e.g., travel videos, instructional videos, branded product videos, etc.) for one or more destinations. The passenger can select a video included in the listing of videos 404 to begin playback of video content related in one or more ways to the destination, during which an embedded purchase element linked to an offer for a product and/or service available at the destination can be presented to the passenger.

FIGS. 4B-D illustrate an example where an embedded purchase element 410 (also shown as 166 in FIGS. 1-3 and described earlier) is linked to an offer for a service available at a destination. More specifically, assuming that a passenger is traveling to Rome Italy, FIG. 4B illustrates playback of video content 412 for a tour of the Roman Colosseum in the graphical user interface of the IFE system 400, during which an embedded purchase element 410 linked to an offer for a Colosseum tour is shown in the graphical user interface of the IFE system 400. As shown, the embedded purchase element 410 can include offer details, such as a description of the offer and a price. A passenger viewing the video content 412 in the graphical user interface of the IFE system 400 can select and activate the embedded purchase element 410 to initiate a purchase transaction for the colosseum tour.

In response to selecting the embedded purchase element 410, the passenger can be provided with additional details about the offer, the ability to finalize a purchase the Colosseum tour, and so forth via the graphical user interface of the IFE system 400. For example, as shown in FIG. 4C, in response to selecting the embedded purchase element, the IFE system can connect to a vendor API for a tour operator, and the vendor API can provide a transaction interface 416 for display in the graphical user interface of the IFE system 400 that allows the passenger to view additional tour details for the colosseum and purchase the colosseum tour.

After purchasing the product and/or service associated with the offer, as shown in FIG. 4D, the vendor API can provide fulfillment information to the passenger by displaying the fulfillment information in the transaction interface 416. The fulfilment information can include a purchase confirmation, receipts, digital tickets, tour locations, itinerary, and the like. In one example, fulfillment information can be sent to the passenger via email, text message, or another form of electronic document delivery.

FIGS. 4E-G illustrate an example where an embedded purchase element 420 is for a product available at a destination. Assuming that a passenger is traveling to Milan Italy, FIG. 4E illustrates playback of video content 418 featuring women's fashion in the graphical user interface of the IFE system 400, during which an embedded purchase element 420 linked to an offer for evening gowns is shown in the graphical user interface of the IFE system 400. In this example, the embedded purchase element 420 can include offer details, such as an indication of a sales event, and an optical code (i.e., QR code) which a passenger can scan using a mobile device. The passenger viewing the video content 418 in the graphical user interface of the IFE system 400 can scan the embedded purchase element 420 to initiate a purchase transaction for the evening gown. For example, scanning the embedded purchase element 420 may open a vendor page 422 (shown in FIG. 4F) on the passenger's device that provides the passenger with additional details about the evening gown and the ability to finalize a purchase of the evening gown using the passenger's device, which can connect to a vendor API for a merchant using a satellite network made available through the aircraft.

After purchasing the evening gown associated with the offer displayed in the embedded purchase element 420, the vendor page 422 can provide fulfillment information to the passenger by displaying the fulfilment information in the vendor page 422, as shown in FIG. 4G. The fulfillment information can include a purchase confirmation, receipts, pickup instructions, delivery information, and other needed information. In one example, the fulfillment information can be sent to the passenger via email, text message, or another form of electronic document delivery.

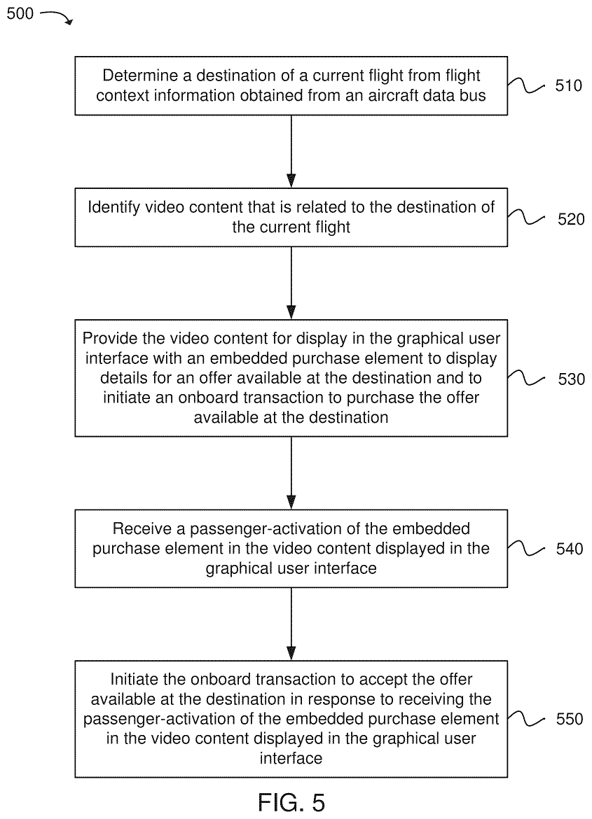

FIG. 5 is a flow diagram illustrating an example method 500 for facilitating destination specific transactions onboard an aircraft using a graphical user interface of an electronic device. The graphical user interface may be a component of a client device that accesses an inflight entertainment system. The client device can be a seatback computing device on the aircraft, or the client device can be a personal electronic device (e.g., mobile device).

As in block 510, a destination of a current flight can be determined from flight context information obtained from an aircraft data bus. The term “flight” can refer to a route of an aircraft or a route of a passenger on the aircraft, which may be different from the aircraft destination. The aircraft data bus may receive aircraft flight information from a plurality of aircraft information systems (e.g., avionics systems) located on the aircraft. Generally speaking, the aircraft flight information available from the aircraft data bus is information that is specific to the aircraft. For example, the flight context information obtained from the aircraft data bus can include: an aircraft origin, an aircraft destination, a passenger destination, an estimated arrival time, an arrival gate, a current latitude and longitude of the aircraft, a current aircraft speed, a current aircraft altitude, an aircraft type, an origin weather report, a destination weather report, or a seatbelt warning status. It is contemplated that in some instances passenger destination information (e.g., connecting flights) can be obtained from an aircraft data bus.

As in block 520, video content that is related to the destination of the current flight can be identified. The video content can feature an activity or service available at the destination, and the embedded purchase element in the video content can initiate an onboard transaction to book the activity. Also, the video content can be a branded product video that features a product available at the destination, and the embedded purchase element in the video content can initiate an onboard transaction to purchase the product.

In one example, video content can be cached in a data store on the aircraft and metadata for the video content can be used by an IFE system to identify an association between the destination and the video content. For example, the IFE system can send a request to a content server located off the aircraft for one or more videos containing embedded purchase elements linked to offers available at one or more destinations, and the IFE system can update the video content cached in the data store located on the aircraft to include the plurality of video content.

In one example, the method 500 can include obtaining a passenger profile for a passenger located on the aircraft and identifying video content based in part on passenger information in the passenger profile that corresponds to the video content. For example, a final destination of a passenger of a current flight can be determined, and video content can be selected that has an association with the final destination of the passenger. In one example, the method 500 can include evaluating the flight context information to determine a status of the current flight (e.g., parked at gate, takeoff, in-flight, distance to destination, meal service, landing approach, etc.) and determining whether to provide certain video content to passengers based in part on the current status of the flight (e.g., such as when a flight is diverted to another destination).

As in block 530, the video content can be provided for display in the graphical user interface with an embedded purchase element to display details for an offer available at the destination and to initiate an onboard transaction to purchase the offer available at the destination. The embedded purchase element can be displayed during at least a portion of playback of the video content in the graphical user interface. For example, the embedded purchase element can be shown during a video segment that features a product or service linked to the embedded purchase element, or the embedded purchase element can be displayed during an entire portion of the video.

As in block 540, a passenger-activation or passenger-selection of the embedded purchase element in the video content displayed in the graphical user interface may be received. In response, as in block 550, an onboard transaction can be initiated to accept the offer available at the destination. For example, a request to process the onboard transaction can be sent to a vendor server located off the aircraft, wherein communication with the vendor server can be transmitted over a satellite communication link. In one example, the request to process the onboard transaction can comprise an API request sent to a vendor API hosted on the vendor server, which processes the onboard transaction for the offer available at the destination. The vendor API may be for a vendor server associated with a vendor of a product and/or service. As an example, a vendor server and an associated vendor API may be for a tour company, spa, theme park, museum, hotel, transportation company, restaurant, duty-free shop, retailer, and the like.

The method 500 may include receiving order fulfilment information from a vendor server in response to successfully processing the onboard transaction and providing the order fulfilment information to a passenger associated with the onboard transaction. For example, the order fulfilment information can be displayed in the graphical user interface to allow the passenger to view the order fulfilment information. Also, the vendor server may send order fulfilment information, such as a purchase confirmation, receipt, digital ticket, pickup instructions, delivery information, itinerary, and the like, to a client device associated with the passenger.

FIG. 6 illustrates an example of a satellite communication system 600. The satellite communication system 600 may include satellite(s) 620 in bidirectional communication with a ground station 610 via a communication link 612 between the satellite 620 and the ground station 610. The satellite 620 may also be in bidirectional communication with an aircraft 650 (e.g., an airplane, helicopter, blimp, or balloon) via a communication link 614 between the satellite 620 and the aircraft 650. The communication link 612 and the communication link 614 may enable communication between the aircraft 650 and the ground station 610 via the satellite 620 while the aircraft 650 is stationary or in motion.

In one example, the satellite communication system 600 may include multiple satellites 620, where each satellite 620 may provide coverage for a service area, and service areas for different satellites may be non-overlapping or overlapping. The satellite communication system 600 may be any suitable type of satellite system, including a geostationary satellite system, medium earth orbit satellite system, low earth orbit satellite system, or combinations thereof. The satellite 620 may have a number of beams directed at different regions on Earth, where the coverage area of each beam may be non-overlapping or overlapping with one or more other beams. The satellite 620 may have one or more spot beams covering different regions on Earth within the service area of the satellite 620. As another example, the satellite 620 may have one or more wide area coverage beams covering the service area of the satellite 620. As yet another example, the satellite 620 may have a combination of spot beams and wide area coverage beams.

In one configuration, the aircraft 650 may include a communication system 670 to facilitate bidirectional communication with the satellite 620 via the communication link 614. The communication system 670 may include an antenna 672 to receive a downlink signal from the satellite 620 and transmit an uplink signal to the satellite 620 via the communication link 614. The aircraft 650 may include a transceiver 674 in communication with the antenna 672, a modem 676 in communication with the transceiver 674, a network access unit 678 (e.g., a router) in communication with the modem 676, and a wireless access point (WAP) 680 in communication with the network access unit 678. Further, the wireless access point 680 may communicate with one or more client devices in the aircraft 650, such as seatback systems 685 and/or client devices 690 (e.g., mobile phones, tablets, laptops) in the aircraft 650. Therefore, the communication system 670 may receive a downlink signal from the satellite 620 and forward the downlink signal to the client devices, and receive an uplink signal from the client devices and forward the uplink signal to the satellite 620, thereby supporting two-way data communications between the client devices within the aircraft 650 and the satellite 620.

In one configuration, the network access unit 678 may be in communication with a server 640 (such as the server 108 described earlier) onboard the aircraft 650. The server 640 may provide an IFE to enable a passenger on the aircraft 650 to access a categorized grouping of product listings through the IFE. The server 640 may send the IFE to the client device 690 onboard the aircraft 650 over a connection for display via the user interface of the client device 690. The server 640 may receive a selection of a product listing included in a categorized grouping via a user interface of the IFE. The server 640 may send the product listing to the client device 690 for display on the client device 690.

In one example, the seatback system 685 may be a fixed or on-aircraft device. The seatback system 685 may communicate with the server 640 via a wired communication link. For example, the seatback system 685 may communicate with the network access unit 678 over a wired communication link, and the network access unit 678 may communicate with the server 640 over a wired communication link. Alternatively, the seatback system 685 may communicate with the server 640 via the network access unit 678 and the wireless access point 680. The seatback system 685 may execute one or more applications that provide an interface for passenger on the aircraft 650 to obtain and consume data.

In one example, the client device 690 may receive and display data, and may be brought onto the aircraft 650 by passengers (which includes crew members). The client devices 690 may execute one or more applications that provide the interface for passenger to obtain and consume data. The passenger may have the option to select/request data for viewing from the interface. When a passenger interacts with the client device 690, the client device 690 may transmit a request for data to the network access unit 678 via the wireless access point 680. The client device 690 may receive requested data from the network access unit 678 via the wireless access point 680. Thus, the wireless access point 680 may provide communication between the network access unit 678 and personal electronic device 690.

In one example, the network access unit 678 may receive requests for data from the client device 690 via the wireless access point 680 and multiplex and forward the requests to the modem 676. The network access unit 678 may receive and demultiplex packets associated with the data, and forward the data to the client device 690 via the wireless access point 680.

In one example, the modem 676 may receive requests for data from the network access unit 678, and the modem 676 may generate modulated data (e.g., transmit intermediate frequency (IF) signal) for delivery to the transceiver 674. Further, the modem 676 may receive requested data as a modulated data (e.g., receive intermediate frequency (IF) signal) from the transceiver 674 and demodulate that data for transmission to the network access unit 678. In one example, the modem 676 may be integrated with the network access unit 678, or alternatively, the modem 676 and the network access unit 678 may be separate components.

In one example, the transceiver 674 may up-convert and amplify modulated data received from the modem 676 to generate an uplink signal for transmission to the satellite 620 via the antenna 672. Similarly, the transceiver 674 may receive a downlink signal from the satellite 620 via the antenna 672. The transceiver 674 may then amplify and down-convert the downlink signal to generate modulated downlink data (e.g., receive IF signal) for demodulation by the modem 676.

In one example, the ground station 610 may also be referred to as an access node, a hub or a gateway. The ground station 610 may include an antenna to transmit an uplink signal to the satellite 620 and receive a downlink signal from the satellite 620. The ground station 610 may be in communication with a vendor server 630 via a network 660. The vendor server 630 may manage a plurality of product listings, as described earlier.

In one example, the network 660 may be any type of network and may include for example, an internet, an internet protocol (IP) network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein. The network 660 may include both wired and wireless connections as well as optical links.

In one example, the ground station 610 may be provided as an interface between the network 660 and the satellite 620. The ground station 610 may receive data and information directed to the seatback system 685 and/or the client device 690 onboard the aircraft 650 from a content server 632 and vendor servers 630 accessible via the network 660. The ground station 610 may format the data and information and transmit an uplink signal to the satellite 620 for subsequent delivery to the aircraft 650 (and then the seatback system 685 and/or the client device 690). Similarly, the ground station 610 may receive a downlink signal from the satellite 620 (e.g., containing requests, data and/or information originating from the seatback system 685 and/or the client device 690 on the aircraft 650) that is directed to a destination accessible via the network 660. The ground station 610 may format the received downlink signal for transmission on the network 660.

In one configuration, the seatback system 685 and/or the client device 690 may be onboard the aircraft 650. Alternatively, the seatback system 685 and/or the client device 690 may be onboard other types of vehicles, such as trains, automobiles (e.g., cars, trucks, busses, etc.), watercraft (e.g., private boats, commercial shipping vessels, cruise ships, etc.) and others.

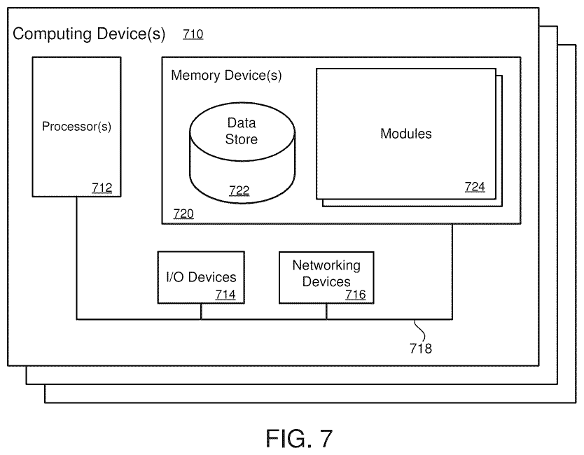

FIG. 7 illustrates a computing device 710 which may execute the foregoing subsystems of this technology. The computing device 710 and the components of the computing device 710 described herein may correspond to the servers and/or client devices described above. The computing device 710 is illustrated on which a high-level example of the technology may be executed. The computing device 710 may include one or more processors 712 that are in communication with memory devices 720. The computing device may include a local communication interface 718 for the components in the computing device. For example, the local communication interface may be a local data bus and/or any related address or control busses as may be desired.

The memory device 720 may contain modules 724 that are executable by the processor(s) 712 and data for the modules 724. In one example, the modules 724 may include an IFE system module, a user interface module, a video service subsystem module, a passenger profile subsystem module, and other modules. The modules 724 may execute the functions described earlier. A data store 722 may also be located in the memory device 720 for storing data related to the modules 724 and other applications along with an operating system that is executable by the processor(s) 712.

Other applications may also be stored in the memory device 720 and may be executable by the processor(s) 712. Components or modules discussed in this description that may be implemented in the form of software using high programming level languages that are compiled, interpreted, or executed using a hybrid of the methods.

The computing device may also have access to I/O (input/output) devices 714 that are usable by the computing devices. An example of an I/O device is a display screen that is available to display output from the computing devices. Other known I/O device may be used with the computing device as desired. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor 712. The term “executable” may mean a program file that is in a form that may be executed by a processor 712. For example, a program in a higher-level language may be compiled into machine code in a format that may be loaded into a random-access portion of the memory device 720 and executed by the processor 712, or source code may be loaded by another executable program and interpreted to generate instructions in a random-access portion of the memory to be executed by a processor. The executable program may be stored in any portion or component of the memory device 720. For example, the memory device 720 may be random access memory (RAM), read only memory (ROM), flash memory, a solid-state drive, memory card, a hard drive, optical disk, floppy disk, magnetic tape, or any other memory components.

The processor 712 may represent multiple processors and the memory device 720 may represent multiple memory units that operate in parallel to the processing circuits.

This may provide parallel processing channels for the processes and data in the system. The local interface 718 may be used as a network to facilitate communication between any of the multiple processors and multiple memories. The local interface 718 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media.

Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A system for facilitating destination specific transactions onboard an aircraft using a graphical user interface of an electronic device, comprising:
at least one processor; and
a memory device including instructions that, when executed by the at least one processor, cause the system to:
determine a destination of a flight from flight context information obtained using an aircraft data bus, wherein the flight context information is from an aircraft information system located on the aircraft;
identify video content that is related to the destination of the flight;
provide the video content for display in the graphical user interface with an embedded purchase element to display details for an offer available at the destination and to initiate an onboard transaction to purchase the offer available at the destination, wherein the embedded purchase element is displayed during at least a portion of playback of the video content in the graphical user interface;
receive a passenger-activation of the embedded purchase element in the video content displayed in the graphical user interface; and
initiate the onboard transaction to accept the offer available at the destination in response to receiving the passenger-activation of the embedded purchase element in the video content displayed in the graphical user interface.

2. The system of claim 1, wherein the memory device further includes instructions that, when executed by the at least one processor, cause the system to provide a travel destination guide in the graphical user interface, wherein the travel destination guide includes a plurality of video content categories for one or more destinations.

3. The system of claim 1, wherein the memory device further includes instructions that, when executed by the at least one processor, cause the system to send a request to process the onboard transaction to a vendor server located off the aircraft, wherein communications between the system and the vendor server, including the request sent to the vendor server, are transmitted over a satellite communication link.

4. The system of claim 3, wherein the request to process the onboard transaction further comprises an application programming interface (API) request for a vendor API hosted on the vendor server that processes the onboard transaction for the offer available at the destination.

5. The system of claim 3, wherein the memory device further includes instructions that, when executed by the at least one processor, cause the system to:
receive order fulfilment information from the vendor server in response to successfully processing the onboard transaction; and
provide the order fulfilment information to a passenger associated with the onboard transaction.

6. The system of claim 1, further comprising a data store located on the aircraft, wherein the video content is cached in the data store and metadata for the video content is used to identify an association between the destination and the video content.

7. The system of claim 6, wherein the memory device further includes instructions that, when executed by the at least one processor, cause the system to:
send, to a content server located off the aircraft, a request for a plurality of video content with associated embedded purchase elements linked to offers available at one or more destinations; and
update the video content cached in the data store located on the aircraft to include the plurality of video content.

8. The system of claim 1, wherein the memory device further includes instructions that, when executed by the at least one processor, cause the system to:
obtain a passenger profile for a passenger located on the aircraft; and
identify the video content based in part on passenger information in the passenger profile that corresponds to the video content.

9. The system of claim 1, wherein the memory device further includes instructions that, when executed by the at least one processor, cause the system to:
evaluate the flight context information to determine a status of the flight; and
determine to provide the video content for display in the graphical user interface based in part on the status of the flight.

10. The system of claim 1, wherein the video content features an activity or service available at the destination, and the embedded purchase element with the video content initiates an onboard transaction to book the activity or service.

11. The system of claim 1, wherein the video content is a branded product video that features a product available at the destination, and the embedded purchase element in the video content initiates an onboard transaction to purchase the product.

12. The system of claim 1, wherein the flight context information obtained from the aircraft data bus includes at least one of: an aircraft origin, an aircraft destination, a passenger destination, an estimated arrival time, an arrival gate, a current latitude and longitude of the aircraft, a current aircraft speed, a current aircraft altitude, an aircraft type, an origin weather report, a destination weather report, or a seatbelt warning status.

13. The system of claim 1, wherein the graphical user interface is a component of a client device that accesses an inflight entertainment system, wherein the client device is a seatback computing device on the aircraft or a personal electronic device.

14. The system of claim 1, wherein the instructions that cause the system to determine at least one destination of a flight further cause the system to:
determine a final destination of a passenger of the flight and select the video content based on an association with the final destination.

15. A computer implemented method for facilitating destination specific transactions onboard an aircraft using a graphical user interface of an electronic device, comprising:
determining a destination of a flight from flight context information obtained using an aircraft data bus, wherein the flight context information is from an aircraft information system located on the aircraft;
identifying video content that is related to the destination of the flight;
providing the video content for display in the graphical user interface with an embedded purchase element to display details for an offer available at the destination and to initiate an onboard transaction to purchase the offer available at the destination, wherein the embedded purchase element is displayed during at least a portion of playback of the video content in the graphical user interface;
receiving a passenger-activation of the embedded purchase element in the video content displayed in the graphical user interface; and
initiating the onboard transaction to accept the offer available at the destination in response to receiving the passenger-activation of the embedded purchase element in the video content displayed in the graphical user interface.

16. The computer implemented method of claim 15, further comprising providing a travel destination guide in the graphical user interface, wherein the travel destination guide includes a plurality of video content categories for one or more destinations.

17. The computer implemented method of claim 15, further comprising sending a request to process the onboard transaction to a vendor server located off the aircraft, wherein communications between the system and the vendor server, including the request sent to the vendor server, are transmitted over a satellite communication link.

18. The computer implemented method of claim 17, wherein the request to process the onboard transaction further comprises an application programming interface (API) request for a vendor API hosted on the vendor server that processes the onboard transaction for the offer available at the destination.

19. The computer implemented method of claim 17, further comprising:
receiving order fulfilment information from the vendor server in response to successfully processing the onboard transaction; and
providing the order fulfilment information to a passenger associated with the onboard transaction.

20. The computer implemented method of claim 15, wherein the video content is cached in a data store on the aircraft and metadata for the video content is used to identify an association between the destination and the video content.

21. The computer implemented method of claim 20, further comprising:
sending, to a content server located off the aircraft, a request for a plurality of video content with associated embedded purchase elements linked to offers available at one or more destinations; and
updating the video content cached in the data store located on the aircraft to include the plurality of video content.

22. The computer implemented method of claim 15, further comprising:
obtaining a passenger profile for the passenger located on the aircraft; and
identifying the video content based in part on passenger information in the passenger profile that corresponds to the video content.

23. The computer implemented method of claim 15, further comprising:
evaluating the flight context information to determine a status of the flight; and
determining to provide the video content for display in the graphical user interface based in part on the status of the flight.

24. The computer implemented method of claim 15, wherein the video content features an activity or service available at the destination, and the embedded purchase element with the video content initiates an onboard transaction to book the activity or service.

25. The computer implemented method of claim 15, wherein the video content is a branded product video that features a product available at the destination, and the embedded purchase element in the video content initiates an onboard transaction to purchase the product.

26. The computer implemented method of claim 15, wherein the flight context information obtained from the aircraft data bus includes at least one of: an aircraft origin, an aircraft destination, a passenger destination, an estimated arrival time, an arrival gate, a current latitude and longitude of the aircraft, a current aircraft speed, a current aircraft altitude, an aircraft type, an origin weather report, a destination weather report, or a seatbelt warning status.

27. The computer implemented method of claim 15, wherein the graphical user interface is a component of a client device that accesses an inflight entertainment system, wherein the client device is a seatback computing device on the aircraft or a personal electronic device.

28. The computer implemented method of claim 15, further comprising determining a final destination of a passenger of the flight and select the video content based on an association with the final destination.

29. A non-transitory machine readable storage medium including instructions embodied thereon for facilitating destination specific transactions onboard an aircraft using a graphical user interface of an electronic device, wherein the instructions, when executed by at least one processor:
determine a destination of a flight from flight context information obtained using an aircraft data bus, wherein the flight context information is from an aircraft information system located on the aircraft;
identify video content that is related to the destination of the flight;
provide the video content for display in the graphical user interface with an embedded purchase element to display details for an offer available at the destination and to initiate an onboard transaction to purchase the offer available at the destination, wherein the embedded purchase element is displayed during at least a portion of playback of the video content in the graphical user interface;
receive a passenger-activation of the embedded purchase element in the video content displayed in the graphical user interface; and
initiate the onboard transaction to accept the offer available at the destination in response to receiving the passenger-activation of the embedded purchase element in the video content displayed in the graphical user interface.

30. The non-transitory machine readable storage medium in claim 29, further comprising instructions, that when executed by the at least one processor, provide a travel destination guide in the graphical user interface, wherein the travel destination guide includes a plurality of video content categories for one or more destinations.

31. The non-transitory machine readable storage medium of claim 29, further comprising instructions, that when executed by the at least one processor, send a request to process the onboard transaction to a vendor server located off the aircraft, wherein communications between the system and the vendor server, including the request sent to the vendor server, are transmitted over a satellite communication link.

32. The non-transitory machine readable storage medium of claim 31, wherein the request to process the onboard transaction further comprises an application programming interface (API) request for a vendor API hosted on the vendor server that processes the onboard transaction for the offer available at the destination.

33. The non-transitory machine readable storage medium of claim 31, further comprising instructions, that when executed by the at least one processor:
receive order fulfilment information from the vendor server in response to successfully processing the onboard transaction; and
provide the order fulfilment information to a passenger associated with the onboard transaction.

34. The non-transitory machine readable storage medium of claim 29, wherein the video content is cached in a data store on the aircraft and metadata for the video content is used to identify an association between the destination and the video content.

35. The non-transitory machine readable storage medium of claim 34, further comprising instructions, that when executed by the at least one processor:
send, to a content server located off the aircraft, a request for a plurality of video content with associated embedded purchase elements linked to offers available at one or more destinations; and
update the video content cached in the data store located on the aircraft to include the plurality of video content.

36. The non-transitory machine readable storage medium of claim 29, further comprising instructions, that when executed by the at least one processor:
obtain a passenger profile for the passenger located on the aircraft; and
identify the video content based in part on passenger information in the passenger profile that corresponds to the video content.

37. The non-transitory machine readable storage medium of claim 29, further comprising instructions, that when executed by the at least one processor:
evaluate the flight context information to determine a status of the flight; and
determine to provide the video content for display in the graphical user interface based in part on the status of the flight.

38. The non-transitory machine readable storage medium of claim 29, wherein the video content features an activity or service available at the destination, and the embedded purchase element with the video content initiates an onboard transaction to book the activity or service.

39. The non-transitory machine readable storage medium of claim 29, wherein the video content is a branded product video that features a product available at the destination, and the embedded purchase element in the video content initiates an onboard transaction to purchase the product.

40. The non-transitory machine readable storage medium of claim 29, wherein the flight context information obtained from the aircraft data bus includes at least one of: an aircraft origin, an aircraft destination, a passenger destination, an estimated arrival time, an arrival gate, a current latitude and longitude of the aircraft, a current aircraft speed, a current aircraft altitude, an aircraft type, an origin weather report, a destination weather report, or a seatbelt warning status.

41. The non-transitory machine readable storage medium of claim 29, wherein the graphical user interface is a component of a client device that accesses an inflight entertainment system, wherein the client device is a seatback computing device on the aircraft or a personal electronic device.

42. The non-transitory machine readable storage medium of claim 29, further comprising instructions, that when executed by the at least one processor, determine a final destination of a passenger of the flight and select the video content based on an association with the final destination.
